(19) United States
(12) Patent Application Publication
(10) Pub. No.: US 2024/0312695 A1
(43) Pub. Date: Sep. 19, 2024

(54) ELECTRONIC COMPONENT

(71) Applicant: TDK Corporation, Tokyo (JP)

(72) Inventors: Nobuyuki OKUZAWA, Tokyo (JP); Yuichi TAKUBO, Tokyo (JP); Ryuji HASHIMOTO, Tokyo (JP); Yuta TAKAHASHI, Tokyo (JP); Hiroki HOSAKA, Tokyo (JP)

(73) Assignee: TDK Corporation, Tokyo (JP)

(21) Appl. No.: 18/429,973

(22) Filed: Feb. 1, 2024

(30) Foreign Application Priority Data
Mar. 17, 2023 (JP) 2023-043080

(51) Int. Cl. H01F 27/29; H01F 17/00

(52) U.S. Cl. CPC H01F 27/292; H01F 17/0013

(57) ABSTRACT

An electronic component includes: an element body having a main surface as a mounting surface; and a pair of external electrodes including an electrode layer embedded inside an opening of the element body and a plating layer formed on the electrode layer, in a first direction perpendicular to the main surface, a main surface of the electrode layer is disposed deeper inside the element body than a virtual plane obtained by virtually extending the main surface in the opening, and the plating layer is formed on the main surface of the electrode layer and covers the electrode layer so as to extend from the virtual plane to a main surface of the element body.

### CROSS REFERENCE TO RELATED APPLICATIONS

This application claims priority to Japanese Patent Application No. 2023-043080 filed on Mar. 17, 2023, the entire contents of which are incorporated by reference herein.

### TECHNICAL FIELD

The present disclosure relates to an electronic component.

### BACKGROUND

An electronic component including an element body and an external electrode formed on a main surface of the element body is known (For example, Japanese Unexamined Patent Publication No. 2018-113299). In Japanese Unexamined Patent Publication No. 2018-113299, the electronic component has a coil portion formed in the element body. The external electrode of the electronic component is bonded to a terminal of another electronic device via solder.

### SUMMARY

In the electronic component having the above configuration, the external electrode includes an electrode layer and a plating layer formed on a surface of the electrode layer by plating. At the time of mounting the electronic component, the external electrode is bonded to a terminal of another electronic device in a state where the solder is applied to the plating layer. However, in the external electrode, there is a possibility that a portion where the solder reaches the electrode layer is generated by thinning the plating layer. In this case, there is a problem that solder erosion of the electrode layer occurs at the portion.

An object of one aspect of the present disclosure is to provide an electronic component capable of suppressing the solder erosion of the electrode layer of the external electrode.

An electronic component according to one aspect of the present disclosure includes: an element body having a main surface as a mounting surface; and a pair of external electrodes including an electrode layer embedded inside an opening of the element body and a plating layer formed on the electrode layer, in a first direction perpendicular to the main surface, a main surface of the electrode layer is disposed inside the element body from a virtual plane obtained by virtually extending the main surface in the opening, and the plating layer is formed on the main surface of the electrode layer and covers the electrode layer so as to extend from the virtual plane to a main surface of the element body.

The electronic component includes the pair of external electrodes having the electrode layer embedded inside the opening of the element body and the plating layer formed on the electrode layer. When the external electrode is mounted on another electronic device by soldering, the plating layer is interposed between the electrode layer and the solder. Therefore, the plating layer can suppress the solder erosion of the electrode layer. Here, in the first direction perpendicular to the main surface, the main surface of the electrode layer is disposed inside the element body from the virtual plane obtained by virtually extending the main surface in the opening. Thus, the electrode layer is formed at a position recessed inward of the element body from the main surface of the element body. On the other hand, the plating layer is formed on the main surface of the electrode layer and covers the electrode layer so as to extend from the virtual plane to the main surface of the element body. Therefore, a distance between the main surface of the electrode layer in the element body and a surface of the plating layer is sufficiently secured at any position. For example, when the plating layer is peeled off, exposure of the electrode layer can be suppressed. From the above, the solder erosion of the electrode layer of the external electrode can be suppressed.

The element body may include a pair of end surfaces facing each other in a second direction perpendicular to the first direction and a pair of side surfaces facing each other in a third direction perpendicular to the first direction and the second direction, and the element body may be disposed between the pair of end surfaces and the external electrodes and between the pair of side surfaces and the external electrodes when viewed from the first direction. In this case, it is possible to suppress the solder from entering the electrode layer in the element body from the side surface side and the end surface side of the element body.

The plating layer may extend to the main surface of the element body on both sides of the electrode layer. In this case, the electrode layer can be covered with the plating layer together with the main surface near an edge portion of the opening of the element body. Thus, it is possible to suppress the exposure of the electrode layer near the edge portion of the opening.

The plating layer may include a first layer containing Ni and a second layer formed on the first layer and containing Au. In this case, bondability between the solder and the external electrode can be improved by the second layer on the surface side.

The first layer may be thicker than the second layer. In this case, an increase in cost can be suppressed by suppressing an amount of Au.

The electrode layer may extend inward of the element body in the first direction at an edge portion of the main surface, and the first layer may be interposed between the edge portion of the electrode layer and the element body. In this case, a thickness of the first layer can be secured at the edge portion of the main surface of the electrode layer. Thus, peeling of the plating layer can be suppressed.

According to the present disclosure, it is possible to provide the electronic component capable of suppressing the solder erosion of the electrode layer of the external electrode.

### BRIEF DESCRIPTION OF THE DRAWINGS

FIG. 1 is a perspective view illustrating an electronic component according to the present embodiment;

FIG. 2A is a cross-sectional view taken along line IIa-IIa in FIG. 1, FIG. 2B is a cross-sectional view taken along line IIb-IIb in FIG. 1, and FIG. 2C is a cross-sectional view taken along line IIc-IIc in FIG. 1;

FIG. 3 is a plan view of the electronic component;

FIG. 4 is an enlarged view of FIG. 2C;

FIGS. 5A to 5F are schematic views illustrating a method for manufacturing the electronic component; and

FIGS. 6A and 6B are schematic views illustrating states at the time of mounting solder.

### DETAILED DESCRIPTION

Hereinafter, an embodiment of the present disclosure will be described in detail with reference to the drawings. In description of the drawings, the same or equivalent elements are denoted by the same reference numerals, and redundant description will be omitted.

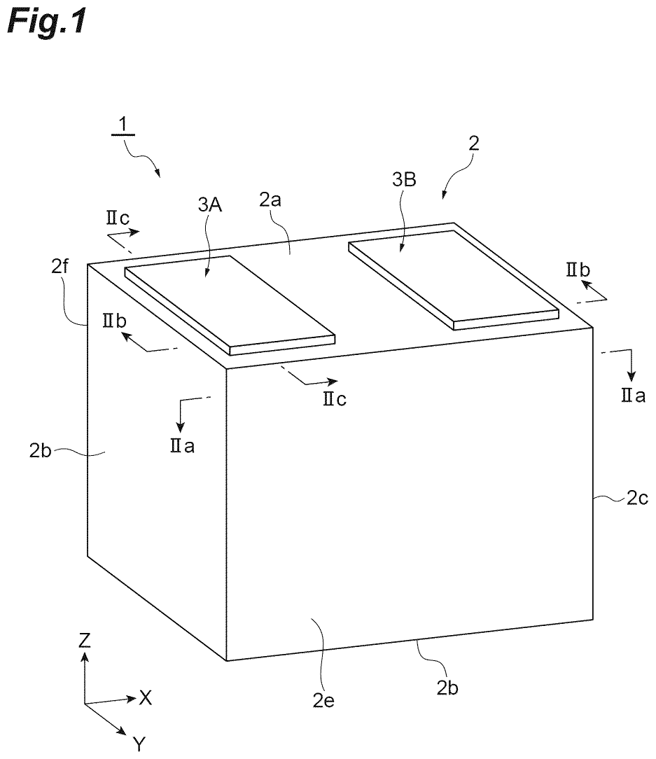

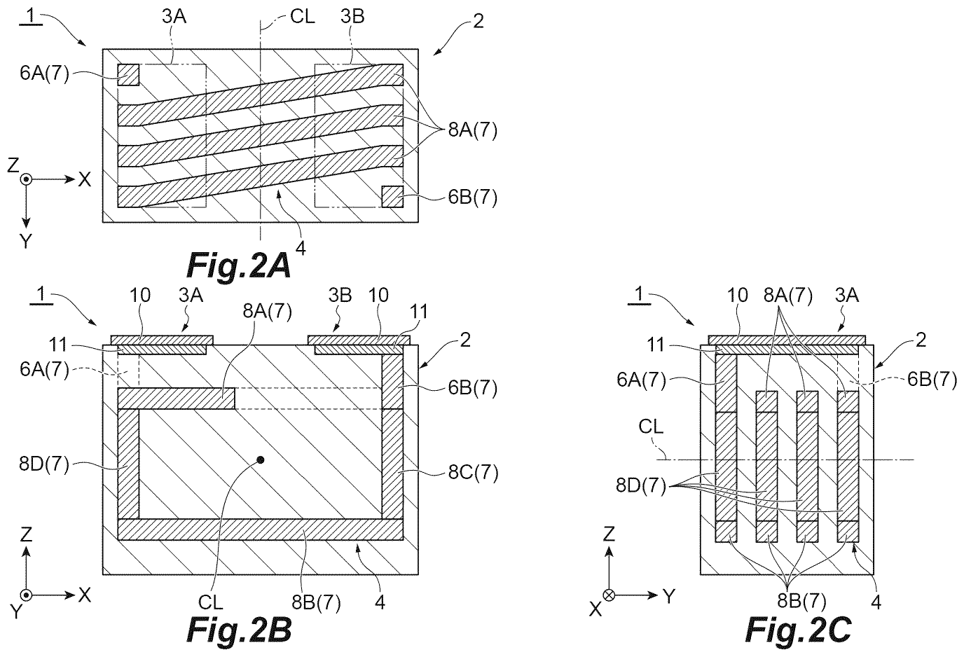

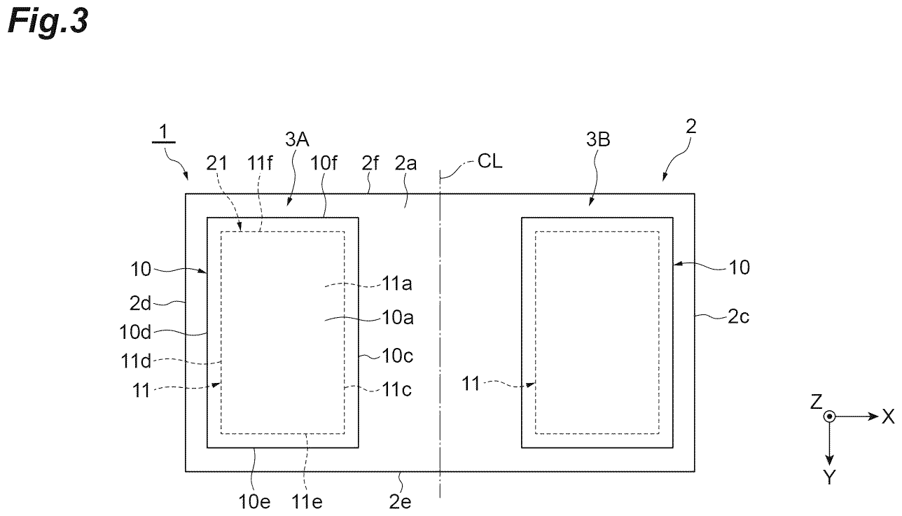

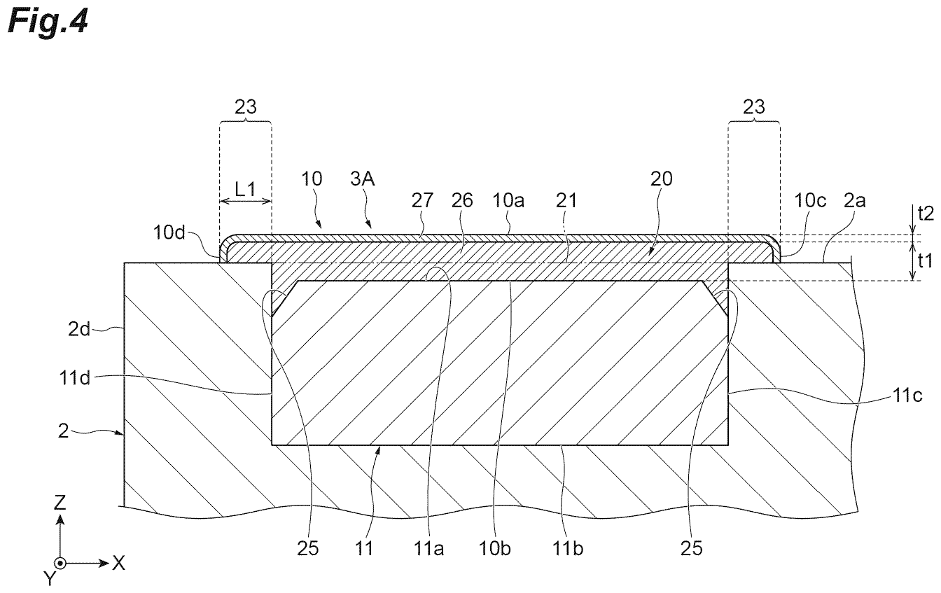

First, a schematic configuration of an electronic component 1 according to the present embodiment will be described with reference to FIGS. 1 to 3. FIG. 1 is a perspective view illustrating the electronic component 1 according to the present embodiment. FIG. 2A is a cross-sectional view taken along line IIa-IIa in FIG. 1. FIG. 2B is a cross-sectional view taken along line IIb-IIb in FIG. 1. FIG. 2C is a cross-sectional view taken along line IIc-IIc in FIG. 1. FIG. 3 is a plan view of the electronic component 1, and FIG. 4 is an enlarged view of FIG. 2C. The electronic component in the present embodiment is formed by laminating a plurality of layers in a Z-axis direction. The layers are integrated to such an extent that boundaries between the layers cannot be visually recognized. In the present embodiment, an X-axis direction, a Y-axis direction, and the Z-axis direction are perpendicular to each other. The Z-axis direction corresponds to a “first direction” in the claims, the X-axis direction perpendicular to the Z-axis direction corresponds to a “second direction” in the claims, and the Y-axis direction perpendicular to the Z-axis direction and the X-axis direction corresponds to a “third direction” in the claims.

As illustrated in FIG. 1, the electronic component 1 includes an element body 2 and external electrodes 3A and 3B.

The element body 2 has a rectangular parallelepiped shape. The element body 2 has, as outer surfaces thereof, main surfaces 2a and 2b facing each other in the Z-axis direction, a pair of end surfaces 2c and 2d facing each other in the X-axis direction, and a pair of side surfaces 2e and 2f facing each other in the Y-axis direction. The main surface 2a is disposed on a positive side in the Z-axis direction, and the main surface 2b is disposed on a negative side in the Z-axis direction. The end surface 2c is disposed on a positive side in the X-axis direction, and the end surface 2d is disposed on a negative side in the X-axis direction. The side surface 2e is disposed on a positive side in the Y-axis direction, and the side surface 2f is disposed on a negative side in the Y-axis direction. For example, when the electronic component 1 is mounted on another electronic device (for example, a circuit board or an electronic component) not illustrated, the main surface 2a is defined as a mounting surface facing the other electronic device.

The external electrodes 3A and 3B are formed on the main surface 2a of the element body 2. Further, the external electrodes 3A and 3B are electrically connected to a coil portion described later in the element body 2. When the electronic component 1 is mounted on the electronic device, the external electrodes 3A and 3B are bonded to terminals of the electronic device by soldering or the like.

As illustrated in FIGS. 2A to 2C, the electronic component 1 includes a coil portion 4 and lead-out portions 6A and 6B inside the element body 2. The coil portion 4 is a portion in which a coil pattern is formed by a plurality of coil conductors 7 in the element body 2. Note that the lead-out portions 6A and 6B are also parts of the coil conductor 7. In the present embodiment, the coil portion 4 is a coil wound around an axis as a center line CL parallel to the Y-axis direction.

The coil portion 4 is wound to form a rectangular annular pattern when viewed from the Y-axis direction. The coil portion 4 includes, as the coil conductor 7, a first side portion 8A disposed on the positive side in the Z-axis direction from the center line CL and extending in the X-axis direction, a second side portion 8B disposed on the negative side in the Z-axis direction from the center line CL and extending in the X-axis direction, a third side portion 8C disposed on the positive side in the X-axis direction from the center line CL and extending in the Z-axis direction, and a fourth side portion 8D disposed on the negative side in the X-axis direction from the center line CL and extending in the Z-axis direction.

The lead-out portion 6A extends in the Z-axis direction from one end of the coil portion 4 and is connected to the external electrode 3A. The lead-out portion 6B extends in the Z-axis direction from the other end of the coil portion 4 and is connected to the external electrode 3B. The lead-out portion 6A is connected to an end portion on the positive side in the Z-axis direction at the fourth side portion 8D disposed on the most negative side in the Y-axis direction. The lead-out portion 6B is connected to an end portion on the positive side in the Z-axis direction at the third side portion 8C disposed on the most positive side in the Y-axis direction.

Next, a detailed configuration of the external electrodes 3A and 3B will be described with reference to FIGS. 3 and 4. FIG. 3 is a plan view of an electronic component 1. FIG. 4 is an enlarged view of FIG. 2C. Note that the external electrode 3A and the external electrode 3B are line-symmetric with respect to the center line CL when viewed from the Z-axis direction. Therefore, hereinafter, the configuration of the external electrode 3A will be described, and description of the external electrode 3B will be omitted. The external electrode 3A includes an electrode layer 11 and a plating layer 10.

As illustrated in FIG. 3, the electrode layer 11 is a layer disposed on the main surface 2a side of the element body 2 and formed in a state of being embedded in the element body 2 (see FIG. 4). The electrode layer 11 has a rectangular shape with its longitudinal direction as the Y-axis direction. The electrode layer 11 has main surfaces 11a and 11b (see FIG. 4), side surfaces 11c and 11d, and end surfaces 11e and 11f. The main surfaces 11a and 11b are surfaces facing each other in the Z-axis direction. The main surface 11a is disposed on the positive side in the Z-axis direction. The main surface 11b is disposed on the negative side in the Z-axis direction. The side surfaces 11c and 11d are surfaces facing each other in the X-axis direction. The side surface 11c is disposed on the positive side in the X-axis direction. The side surface 11d is disposed on the negative side in the X-axis direction. The end surfaces 11e and 11f are surfaces facing each other in the Y-axis direction. The end surface 11e is disposed on the positive side in the Y-axis direction. The end surface 11f is disposed on the negative side in the Y-axis direction.

The side surface 11c of the electrode layer 11 is disposed at a position away from the center line toward the negative side in the X-axis direction. The side surface 11d is disposed at a position away from the end surface 2d of the element body 2 toward the positive side in the X-axis direction. The end surface 11e is disposed at a position away from the side surface 2e of the element body 2 toward the negative side in the Y-axis direction. The end surface 11f is disposed at a position away from the side surface 2f of the element body 2 toward the positive side in the Y-axis direction.

The plating layer 10 is a layer provided on the electrode layer 11. The plating layer 10 has a rectangular shape with its longitudinal direction as the Y-axis direction. The plating layer 10 has main surfaces 10a and 10b (see FIG. 4), side surfaces 10c and 10d, and end surfaces 10e and 10f. The main surfaces 10a and 10b are surfaces facing each other in the Z-axis direction. The main surface 10a is disposed on the positive side in the Z-axis direction. The main surface 10b is disposed on the negative side in the Z-axis direction. The side surfaces 10c and 10d are surfaces facing each other in the X-axis direction. The side surface 10c is disposed on the positive side in the X-axis direction. The side surface 10d is disposed on the negative side in the X-axis direction. The end surfaces 10e and 10f are surfaces facing each other in the Y-axis direction. The end surface 10e is disposed on the positive side in the Y-axis direction. The end surface 10f is disposed on the negative side in the Y-axis direction.

The plating layer 10 covers the electrode layer 11 and is provided such that an outer edge of the plating layer 10 protrudes from an outer edge of the electrode layer 11. Therefore, the surfaces 10c, 10d, 10e, and 10f of the plating layer 10 are arranged on an outer peripheral side of the surfaces 11c, 11d, 11e, and 11f of the electrode layer 11. Further, the side surface 10c of the plating layer 10 is disposed at a position away from the center line toward the negative side in the X-axis direction. The side surface 10d is disposed at a position away from the end surface 2d of the element body 2 toward the positive side in the X-axis direction. The end surface 10e is disposed at a position away from the side surface 2e of the element body 2 toward the negative side in the Y-axis direction. The end surface 10f is disposed at a position away from the side surface 2f of the element body 2 toward the positive side in the Y-axis direction. With such a configuration, the element body 2 is disposed between the pair of end surfaces 2c and 2d and the external electrodes 3A and 3B and between the pair of side surfaces 2e and 2f and the external electrodes 3A and 3B when viewed from the Z-axis direction.

The plating layer 10 is a layer exposed from the main surface 2a of the element body 2. In the plating layer 10, at least the main surface 10a on the positive side in the Z-axis direction is exposed from the main surface 2a of the element body 2. Further, in the present embodiment, the side surfaces 10c and 10d and the end surfaces 10e and 10f are also exposed from the main surface 2a (see FIG. 4).

The external electrode 3A will be described in more detail with reference to FIG. 4. An opening 20 recessed toward the negative side in the Z-axis direction is formed in the main surface 2a of the element body 2. A plane obtained by virtually extending the main surface 2a in the opening 20 is defined as a virtual plane 21. In FIG. 4, the virtual plane 21 is indicated by a two-dot chain line. The virtual plane 21 has a rectangular shape similar to that of the electrode layer 11 when viewed from the Z-axis direction (see FIG. 3).

In the Z-axis direction, the main surface 11a of the electrode layer 11 is disposed inside the element body 2 from the virtual plane 21. That is, the main surface 11a of the electrode layer 11 is disposed at a position on the negative side in the Z-axis direction from the virtual plane 21. A separation distance in the Z-axis direction between the main surface 11a and the virtual plane 21 is not particularly limited, but may be, for example, about 0.1 to 5.0 μm.

The electrode layer 11 extends inward (toward the negative side) of the element body 2 in the Z-axis direction at an edge portion of the main surface 11a. A recess 25 extending toward the negative side in the Z-axis direction are formed as it goes to the outer peripheral side in the edge portion of the main surface 11a.

The plating layer 10 is formed on the main surface 11a of the electrode layer 11 and covers the electrode layer 11 so as to extend from the virtual plane 21 to the main surface 2a of the element body 2. The plating layer 10 enters the opening 20 from the main surface 2a of the element body 2 via the virtual plane 21 and extends toward the negative side in the Z-axis direction, thereby extending to the main surface 11a on the positive side in the Z-axis direction of the electrode layer 11. The main surface 10b on the negative side in the Z-axis direction of the plating layer 10 is bonded to the main surface 11a on the positive side in the Z-axis direction of the electrode layer 11. The plating layer 10 protrudes to the positive side in the Z-axis direction from the virtual plane 21, that is, the main surface 2a. Therefore, the main surface 10a of the plating layer 10 on the positive side in the Z-axis direction is disposed at a position away from the virtual plane 21 and the main surface 2a toward the positive side in the Z-axis direction.

Further, the plating layer 10 extends to the main surface 2a of the element body 2 on both sides of the electrode layer 11. The plating layer 10 extends to the main surface 2a of the element body 2 on both sides of the electrode layer 11 in the X-axis direction. The plating layer 10 extends to the main surface 2a of the element body 2 on both sides of the electrode layer 11 in the Y-axis direction. The plating layer 10 has an extended portion 23 protruding from the electrode layer 11 toward the both sides in the X-axis direction and the both sides in the Y-axis direction as viewed in the Z-axis direction. Thus, edge portions of the main surface 2a near four sides of the virtual plane 21 are covered with the extended portion 23 of the plating layer 10. Note that a dimension L1 of the extended portion 23 is not particularly limited, but may be about 0.5 to 5 μm.

The plating layer 10 includes a first layer 26 containing Ni and a second layer 27 formed on the first layer 26 and containing Au. The first layer 26 enters the opening 20 and protrudes from the opening 20 to form the extended portion 23 described above. In addition, the first layer 26 is interposed between the recess 25 at the edge portion of the electrode layer 11 and the element body 2.

The second layer 27 covers a surface of the first layer 26 exposed from the main surface 2a. Thus, the second layer 27 forms the main surface 10a, the side surfaces 10c and 10d, and the end surfaces 10e and 10f (see FIG. 3) of plating layer 10. Note that the electrode layer 11 may contain Cu. However, materials of the plating layer 10 and the electrode layer 11 are not limited to those exemplified above.

The first layer 26 is thicker than the second layer 27. A thickness t1 of the first layer 26 may be about 1.0 to 5.0 μm. A thickness t2 of the second layer 27 may be about 0.03 to 1.5 μm.

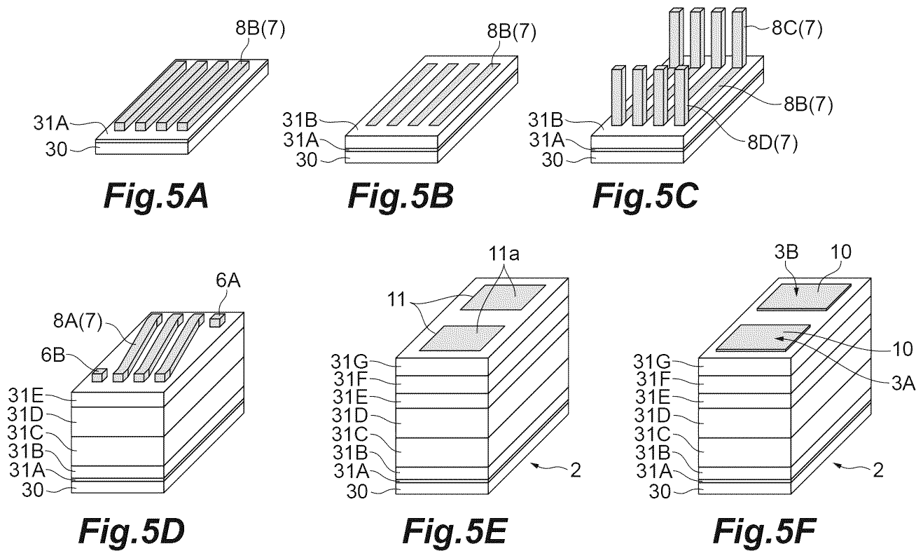

Next, a method for manufacturing the electronic component 1 will be described with reference to FIGS. 5A to 5F.

First, as illustrated in FIG. 5A, a base member 30 to be a part of the element body 2 is prepared, and an insulating layer 31A is formed by applying a material of the element body 2 to an upper surface of the base member 30. The second side portion 8B of the coil conductor 7 is formed on an upper surface of the insulating layer 31A. The second side portion 8B is formed by forming an electrode film on the upper surface of the insulating layer 31A, exposing the electrode film using a resist, plating the conductor then peeling off the resist, and etching the electrode film. Note that in the subsequent formation of the coil conductor 7, the same step is performed.

Next, as illustrated in FIG. 5B, the second side portion 8B is embedded with an insulating layer 31B, and an upper surface thereof is polished. Next, as illustrated in FIG. 5C, the side portions 8C and 8D of the coil conductor 7 are formed to rise. Note that the side portions 8C and 8D may be formed by repeating a step of forming a part of the coil conductor 7 and embedding the part with an insulating layer a plurality of times. Here, as illustrated in FIG. 5D, a step for two layers of insulating layers 31C and 31D is performed to form the side portions 8C and 8D. Thereafter, the first side portion 8A and an insulating layer 31E of the coil conductor 7 are formed. The lead-out portions 6A and 6B are formed for the first side portion 8A, and an insulating layer 31F (see FIG. 5E) that embeds the lead-out portions 6A and 6B is formed.

Next, as illustrated in FIG. 5E, the electrode layer 11 and an insulating layer 31G that embeds the electrode layer 11 are formed. Thus, the element body 2 is completed. In a stage where the insulating layer 31G is formed and polished, the main surface 2a of the element body 2 and the main surface 11a of the electrode layer 11 are flush with each other. By performing Cu etching on this, the main surface 11a of the electrode layer 11 is processed be disposed at a position lower than the main surface 2a. Then, as illustrated in FIG. 5F, the plating layer 10 is formed on the main surface 11a of the electrode layer 11. Thus, the external electrodes 3A and 3B are completed.

Next, operations and effects of the electronic component 1 according to the present embodiment will be described.

The electronic component 1 includes a pair of external electrodes 3A and 3B having the electrode layer 11 embedded inside the opening 20 of the element body 2 and the plating layer 10 formed on the electrode layer 11. When the external electrodes 3A and 3B are mounted on another electronic device by soldering, the plating layer 10 is interposed between the electrode layer 11 and the solder. Therefore, the plating layer 10 can suppress solder erosion of the electrode layer 11. Here, in the Z-axis direction perpendicular to the main surface 2a, the main surface 11a of the electrode layer 11 is disposed inside the element body 2 from the virtual plane 21 obtained by virtually extending the main surface 2a in the opening 20. Thus, the electrode layer 11 is formed at a position recessed inward of the element body 2 from the main surface 2a of the element body 2. On the other hand, the plating layer 10 is formed on the main surface 11a of the electrode layer 11 and covers the electrode layer 11 so as to extend from the virtual plane 21 to the main surface 2a of the element body 2. Therefore, a distance between the main surface 11a of the electrode layer 11 in the element body 2 and a surface of the plating layer 10 is sufficiently secured at any position. For example, when the plating layer 10 is peeled off, exposure of the electrode layer 11 can be suppressed. From the above, the solder erosion of the electrode layers 11 of the external electrodes 3A and 3B can be suppressed.

The element body 2 may include the pair of end surfaces 2c and 2d facing each other in the X-axis direction and the pair of side surfaces 2e and 2f facing each other in the Y-axis direction, and the element body 2 may be disposed between the pair of end surfaces 2c and 2d and the external electrodes 3A and 3B and between the pair of side surfaces 2e and 2f and the external electrodes 3A and 3B when viewed from the Z-axis direction. In this case, it is possible to suppress the solder from entering the electrode layer 11 in the element body 2 from the side surfaces 2e and 2f side and the end surfaces 2c and 2d side of the element body 2.

The plating layer 10 may extend to the main surface 2a of the element body 2 on both sides of the electrode layer 11. In this case, the electrode layer 11 can be covered with the plating layer 10 together with the main surface 2a near an edge portion of the opening 20 of the element body 2. Thus, it is possible to suppress the exposure of the electrode layer 11 near the edge portion of the opening 20.

The plating layer 10 may include the first layer 26 containing Ni and the second layer 27 formed on the first layer 26 and containing Au. In this case, bondability between the solder and the external electrodes 3A and 3B can be improved by the second layer 27 on the surface side.

The first layer 26 may be thicker than the second layer 27. In this case, an increase in cost can be suppressed by suppressing an amount of Au.

The electrode layer 11 may extend inward of the element body 2 in the Z-axis direction at an edge portion of the main surface 11a, and the first layer 26 may be interposed between the edge portion of the electrode layer 11 and the element body 2. In this case, a thickness of the first layer 26 can be secured at the edge portion of the main surface 11a of the electrode layer 11. Thus, peeling of the plating layer 10 can be suppressed.

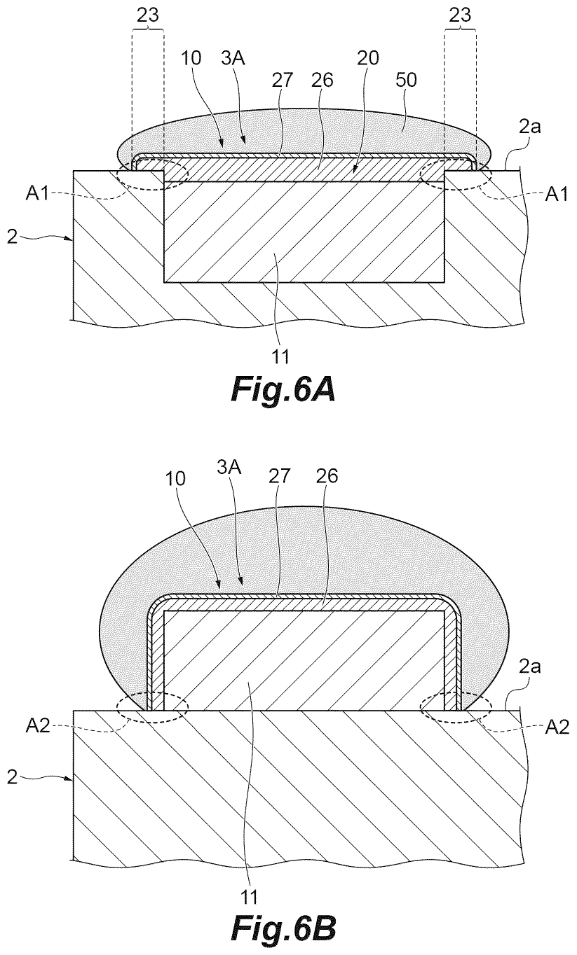

FIG. 6B is a schematic view illustrating a state in which solder 50 is mounted on the external electrode 3A of an electronic component 100 according to a comparative example. As illustrated in FIG. 6B, in the comparative example, the electrode layer 11 is formed on the main surface 2a of the element body 2, and the plating layer 10 is formed around the electrode layer 11. In such a configuration, since adhesion of the plating layer 10 on the element body 2 is low at a root portion (“A2” in FIG. 6B) of the external electrode 3A, the plating layer 10 is easily peeled off. In addition, when the plating layer 10 is peeled off, the electrode layer 11 is easily exposed. Therefore, the solder erosion of the electrode layer 11 occurs at the time of mounting the solder 50.

FIG. 6A is a schematic view illustrating a state in which the solder 50 is mounted on the external electrode 3A of the electronic component 1 according to the present embodiment. As illustrated in FIG. 6A, the plating layer 10 is formed to cover the electrode layer 11. As indicated by “A1” in FIG. 6A, the plating layer 10 having a sufficient thickness is formed between the electrode layer 11 and an outside, near an outer edge of the external electrode 3A. Therefore, even if the plating layer 10 is peeled off at the time of mounting the solder 50, since the electrode layer 11 is hardly exposed, the solder erosion is reduced.

The present disclosure is not limited to the above-described embodiment.

For example, in the above-described embodiment, the plating layer 10 extends from all four sides of the electrode layer 11 to the main surface 2a, but only needs to extend from at least one side to the main surface 2a.

A layer structure of the plating layer 10 is not limited to that of the above-described embodiment.

### Embodiment 1

An electronic component including:
an element body having a main surface as a mounting surface; and
a pair of external electrodes including an electrode layer embedded inside an opening of the element body and a plating layer formed on the electrode layer, in which
in a first direction perpendicular to the main surface, a main surface of the electrode layer is disposed inside the element body from a virtual plane obtained by virtually extending the main surface in the opening, and
the plating layer is formed on the main surface of the electrode layer and covers the electrode layer so as to extend from the virtual plane to a main surface of the element body.

### Embodiment 2

The electronic component according to Embodiment 1, in which
the element body includes a pair of end surfaces facing each other in a second direction perpendicular to the first direction and a pair of side surfaces facing each other in a third direction perpendicular to the first direction and the second direction, and
the element body is disposed between the pair of end surfaces and the external electrodes and between the pair of side surfaces and the external electrodes when viewed from the first direction.

### Embodiment 3

The electronic component according to Embodiment 1 or 2, in which the plating layer extends to the main surface of the element body on both sides of the electrode layer.

### Embodiment 4

The electronic component according to any one of Embodiments 1 to 3, in which the plating layer includes a first layer containing Ni and a second layer formed on the first layer and containing Au.

### Embodiment 5

The electronic component according to Embodiment 4, in which the first layer is thicker than the second layer.

### Embodiment 6

The electronic component according to Embodiment 4 or 5, in which
the electrode layer extends inward of the element body in the first direction at an edge portion of the main surface, and
the first layer is interposed between the edge portion of the electrode layer and the element body.

### REFERENCE SIGNS LIST

1 Electronic component
2 Element body
3A, 3B External electrode
10 Plating layer
11 Electrode layer
26 First layer
27 Second layer

What is claimed is:

1. An electronic component comprising:
an element body having a main surface as a mounting surface; and
a pair of external electrodes including an electrode layer embedded inside an opening of the element body and a plating layer formed on the electrode layer, wherein
in a first direction perpendicular to the main surface, a main surface of the electrode layer is disposed deeper inside the element body than a virtual plane obtained by virtually extending the main surface in the opening, and
the plating layer is formed on the main surface of the electrode layer and covers the electrode layer so as to extend from the virtual plane to a main surface of the element body.

2. The electronic component according to claim 1, wherein
the element body includes a pair of end surfaces facing each other in a second direction perpendicular to the first direction and a pair of side surfaces facing each other in a third direction perpendicular to the first direction and the second direction, and
the element body is disposed between the pair of end surfaces and the external electrodes and between the pair of side surfaces and the external electrodes when viewed from the first direction.

3. The electronic component according to claim 1, wherein the plating layer extends to the main surface of the element body on both sides of the electrode layer.

4. The electronic component according to claim 1, wherein the plating layer includes a first layer containing Ni and a second layer formed on the first layer and containing Au.

5. The electronic component according to claim 4, wherein the first layer is thicker than the second layer.

6. The electronic component according to claim 4, wherein
the electrode layer extends inward of the element body in the first direction at an edge portion of the main surface, and
the first layer is interposed between the edge portion of the electrode layer and the element body.
